(19) United States
(12) Patent Application Publication
(10) Pub. No.: US 2008/0061565 A1
(43) Pub. Date: Mar. 13, 2008

(54) Magnetic switch with auto-release function

(75) Inventors: Yung-Ta Lee, Sinjhuang City (TW); Chia-Cheng Chen, Sinjhuang City (TW); Hung-Ta Kuo, Sinjhuang City (TW)

Correspondence Address: John G. Chupa;Law Offices of John Chupa & Associates, P.C., Suite 50, 28535 Orchard Lake Road, Farmington Hills, MI, 48334, US

(73) Assignee: Jarllytec Co., Ltd.

(21) Appl. No.: 11/724,087

(22) Filed: Mar. 14, 2007

(30) Foreign Application Priority Data
Sep. 12, 2006 (TW) 095216229

(51) Int. Cl. E05C 19/16

(52) U.S. Cl. 292/251.5

(57) ABSTRACT

A magnetic switch is disclosed to include a first magnetic device affixed to a second member of a lifting cover type of a article, a driven rod slidably mounted in a first member of the lifting cover type of the article that is hinged to the second member, a holder member mounted on the driven rod and holding a second magnetic device for attracting the first magnetic device to keep the fist member and the second member in the closed position, a spring member that imparts a pressure to the driven rod to hold the holder member in such a position that the second magnetic device attracts the first magnetic device, and a key extending out of the first member of the lifting cover type of the article for operation by hand to move the driven rod to the position where the second magnetic device repulses the first magnetic device to force the second member away from the first member.

### BACKGROUND OF THE INVENTION

1. Field of the Invention

The present invention relates generally to a magnetic switch and more particularly, to such a magnetic switch that provides an auto-release function.

2. Description of the Related Art

A mobile electronic product, for example, a notebook computer is comprised of a first member, i.e., the cover, a second member, i.e., the base member, a hinge structure coupled between the cover and the base member for allowing the cover to be opened from or closed on the base member, and a lock for locking the cover to the base member in the closed position. The lock comprises at least one hook movably mounted in the cover, and at least one key for operation by the user to move the at least one hook between a locking position where the at least one hook is respectively hooked in a respective hook hole in the base member and an unlocking position where the at least one hook is released from the respective hook hole. Because each hook extends out of the cover and each hook hole is a recessed hole on one side of the base member, the arrangement of the at least one hook and the at least one hook hole obstructs the sense of beauty of the outer appearance of the mobile electronic product. Further, the at least one hook may be deformed or broken accidentally, resulting in failure of the lock.

To eliminate the aforesaid problem, electronic devices with a magnetic switch are developed. Taiwan Patent No. 1238309 discloses an electronic device, which comprises a first member that has at least one accommodation space, at least one magnetic element respectively mounted in the at least one accommodation space of the first member, a second member hinged to the first member, and at least one magnetic guide member mounted in the second member corresponding to the at least one magnetic element, and a magnetically insulative member mounted in the at least one accommodation space of the first member and disposed between the first member and the at least one magnetic element. By means of magnetic attraction between the at least one magnetic element and the magnetic guide member, the first member and the second member are locked in the closed position. However, when opening the first member from the second member, the user must insert the fingers into the gap between the first member and the second member and then pull the first member and the second member apart with both hands to overcome the magnetic attractive force between the at least one magnetic element and the magnetic guide member. This unlocking procedure is inconvenient.

### SUMMARY OF THE INVENTION

The present invention has been accomplished under the circumstances in view. According to one embodiment of the present invention, the magnetic switch is installed in hinged first member and second member of a lifting cover type article for locking the hinged first member and second member when the hinged first member and second member are closed together. The magnetic switch comprises a fixed unit fixedly mounted in the front end edge of the second member of the lifting cover type article, and a movable unit mounted in the front end edge of the first member of the lifting cover type article. The fixed unit comprises at least one magnetic device. The movable unit comprises a driven rod arranged in parallel and movable relative to the front end edge of the first member of the lifting cover type article, a holder member fixedly mounted on the driven rod movable with the driven rod relative to the first member of the lifting cover type article between a first position and a second position, at least one magnetic device mounted in the holder member and adapted to attract the at least one magnetic device of the fixed unit when the holder member is in the first position and to repulse the at least one magnetic device of the fixed unit when the holder member is in the second position, spring means mounted on the driven rod and connected between a part of the driven rod and a part of the first member of the lifting cover type article to support the holder member in the first position, and a key extending out of the front end edge of the first member of the lifting cover type article for operation by the user to move the driven rod relative to the front end edge of the first member of the lifting cover type article against the spring power of the spring means and to further move the holder member from the first position to the second position.

According to another embodiment of the present invention, the magnetic switch is installed in hinged first member and second member of a lifting cover type article for locking the hinged first member and second member when the hinged first member and second member are closed together. The magnetic switch comprises a fixed unit fixedly mounted in the front end edge of the second member of the lifting cover type article, and a movable unit mounted in the front end edge of the first member of the lifting cover type article. The fixed unit comprises at least one magnetic device. The movable unit comprises a driven rod arranged in parallel and movable relative to the front end edge of the first member of the lifting cover type article, a holder member pivoted to the first member of the lifting cover type article and rotatable by the driven rod through 180° between a first position and a second position when the driven rod is moved relative to the first member of the lifting cover type article, a magnetic device mounted in the holder member and adapted to attract the at least one magnetic device of the fixed unit when the holder member is in the first position and to repulse the at least one magnetic device of the fixed unit when the holder member is in the second position, spring means mounted on the driven rod and connected between a part of the driven rod and a part of the first member of the lifting cover type article to support the driven rod in the position where the holder member is in the first position, and a key extending out of the front end edge of the first member of the lifting cover type article for operation by the user to move the driven rod relative to the front end edge of the first member of the lifting cover type article against the spring power of the spring means and to further move the holder member from the first position to the second position.

Further, the lifting cover type article can be an electronic product, for example, mobile computer, personal digital assistant, or electronic dictionary.

Further, the driven rod is inserted through a lug inside the first member of the lifting cover type article, having a collar on the middle. The spring means is a compressed spring sleeved onto the driven rod and stopped between the collar of the driven rod and the lug of said first member of the lifting cover type article.

Further, the key of the movable unit can be a sliding key or bush button extending out of the front end edge of the first member of the lifting cover type article for operation by the user to move the driven rod relative to the first member of the lifting cover type article.

### BRIEF DESCRIPTION OF THE DRAWINGS

FIG. 1 is an exploded view of a magnetic switch in accordance with a first embodiment of the present invention (the fixed unit excluded).

FIG. 2 is an applied view of the first embodiment of the present invention, showing installation of the magnetic switch in a lifting cover type mobile electronic product.

FIG. 3 is a schematic drawing showing the locking status of the first embodiment of the present invention.

FIG. 4 is a schematic drawing showing the unlocked status of the first embodiment of the present invention.

FIG. 5 is an exploded view of a magnetic switch in accordance with a second embodiment of the present invention (the fixed unit excluded).

FIG. 6 is an applied view of the second embodiment of the present invention, showing installation of the magnetic switch in a lifting cover type mobile electronic product.

FIG. 7 is a schematic drawing showing the locking status of the second embodiment of the present invention.

FIG. 8 is a schematic drawing showing the unlocked status of the second embodiment of the present invention.

FIG. 9 is an exploded view of a magnetic switch in accordance with a third embodiment of the present invention (the fixed unit excluded).

FIG. 10 is an applied view of the third embodiment of the present invention, showing installation of the magnetic switch in a lifting cover type mobile electronic product.

FIG. 11 is a schematic drawing showing the locking status of the third embodiment of the present invention.

FIG. 12 is a schematic drawing showing the unlocked status of the third embodiment of the present invention.

### DETAILED DESCRIPTION OF THE INVENTION

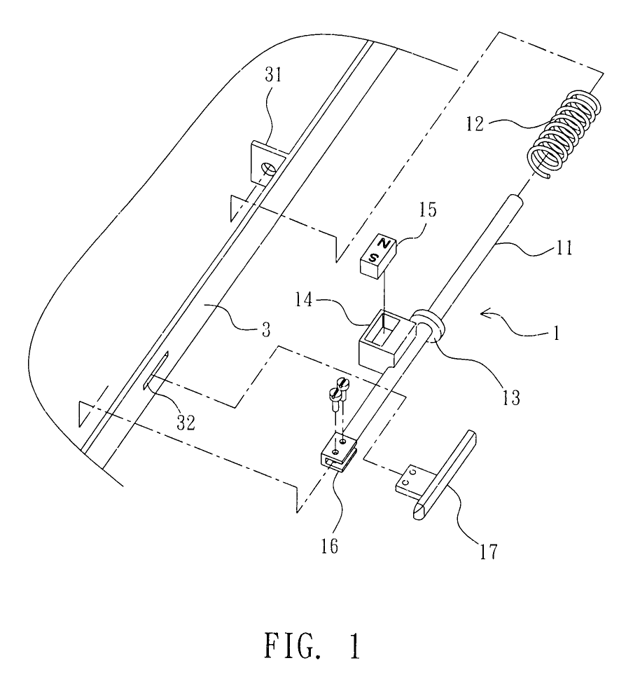

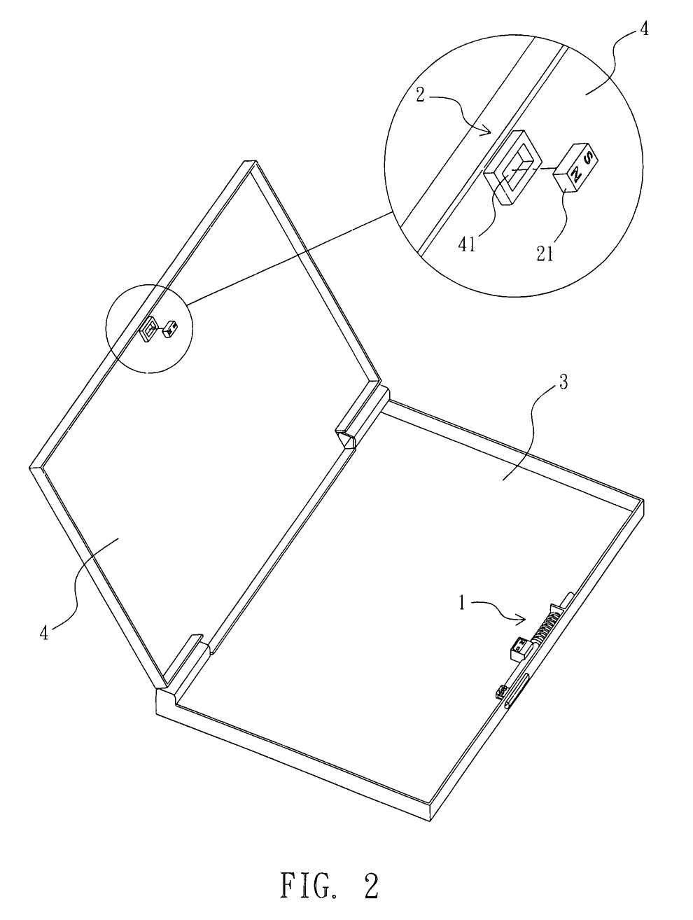

Referring to FIGS. 1 and 2, a magnetic switch in accordance with a first embodiment of the present invention is shown comprised of a movable unit 1 and a fixed unit 2.

The magnetic switch is used in a lifting cover type article, for example, an electronic product such as mobile computer, PDA, electronic dictionary, or the like. The movable unit 1 is mounted in the front end edge of the first member 3 of the two hinged members of the lifting cover type article, and the fixed unit 2 is mounted in the corresponding end edge the second member 4 of the two hinged members of the lifting cover type article. Alternatively, the movable unit 1 and the fixed unit 2 can be respectively mounted in the second member 4 and the first member 3.

The movable unit 1 comprises a driven rod 11, which is inserted with its one end through a lug 31 at the back side of the front end edge of the first member 3 and kept in parallel to the front end edge of the first member 3 and has a collar 13 on the middle, a spring member, for example, a compression spring 12 sleeved onto one end of the driven rod 11 and stopped between the collar 13 and the lug 31, a holder member 14, for example, a box fixedly fastened to the driven rod 11 at one side of the collar 13 opposite to the compression spring 12, a magnetic device 15 mounted in the holder member 14, a connecting member, for example, a U-lug 16 fixedly provided at the other end of the driven rod 11, and a sliding key 17, which is inserted through a sliding slot 32 on the front end edge of the first member 3 and fixedly connected to the U-lug 16 for moving the driven rod 11 along the sliding slot 32. The magnetic device 15 has an N pole at one end and an S pole at the other end for attracting or repulsing a magnetic device 21 of the fixed unit 2 to lock or unlock the magnetic switch.

Referring to FIG. 2, the movable unit 1 according to the aforesaid statement is mounted inside the front end edge of the first member 3. The fixed unit 2 is comprised of a magnetic device 21 at the back side of the front end edge of the second member 4, which is comprised of a box 41. The location of the box 41 is so selected that the magnetic device 21 does no work with the magnetic device 15 when the sliding key 17 is not operated.

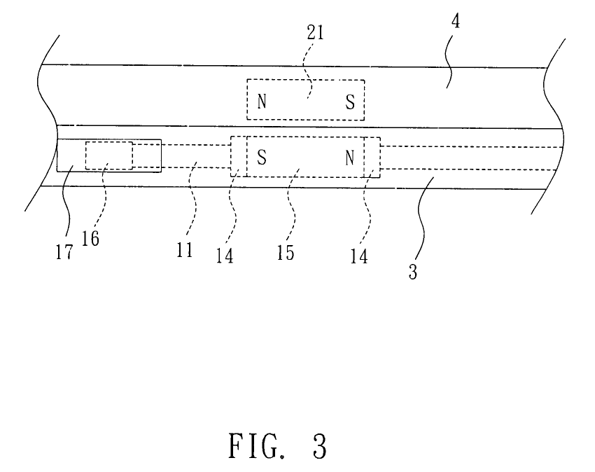

Referring to FIG. 3, when the first member 3 and the second member 4 are closed, a magnetic attractive force is produced between the N and S poles of the magnetic device 15 of the movable unit 1 and the S and N poles of the magnetic device 21 of the fixed unit 2, thereby locking the magnetic switch. The magnetic devices 15 and 21 can be permanent magnets or electromagnets.

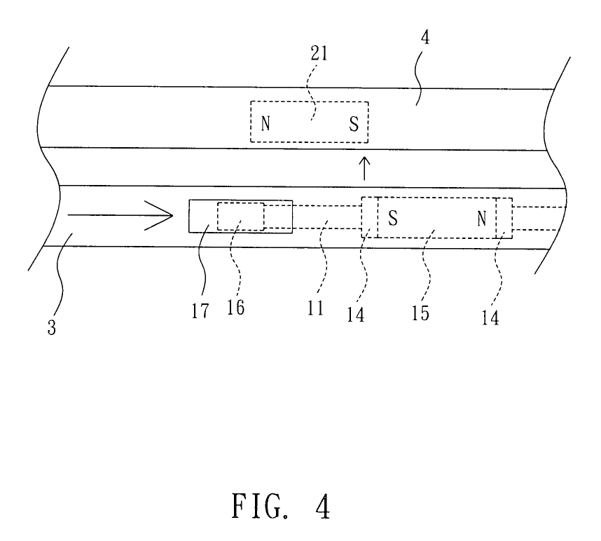

Referring to FIG. 4, when unlocking the magnetic switch, operate the sliding key 17 to move the driven rod 11 against the spring power of the compression spring 12 to have the S-pole of the magnetic device 15 be aimed at the S-pole of the magnetic device 21. At this time, a magnetic repulsion is produced to unlock the magnetic switch. Therefore, the user can operate the sliding key 17 conveniently with one hand to unlock the magnetic switch and to further open the lifting cover type article.

Further, two ore more holder members 14, i.e., boxes may be provided at the driven rod 11 to carry multiple magnetic devices 15, and corresponding magnetic devices 21 are provided at the second member 4 to enhance the locking power between the first member 3 and the second member 4. By means of one single sliding key 17, multiple sets of magnetic devices 15 and 21 are conveniently controlled between the locking position and the unlocking position.

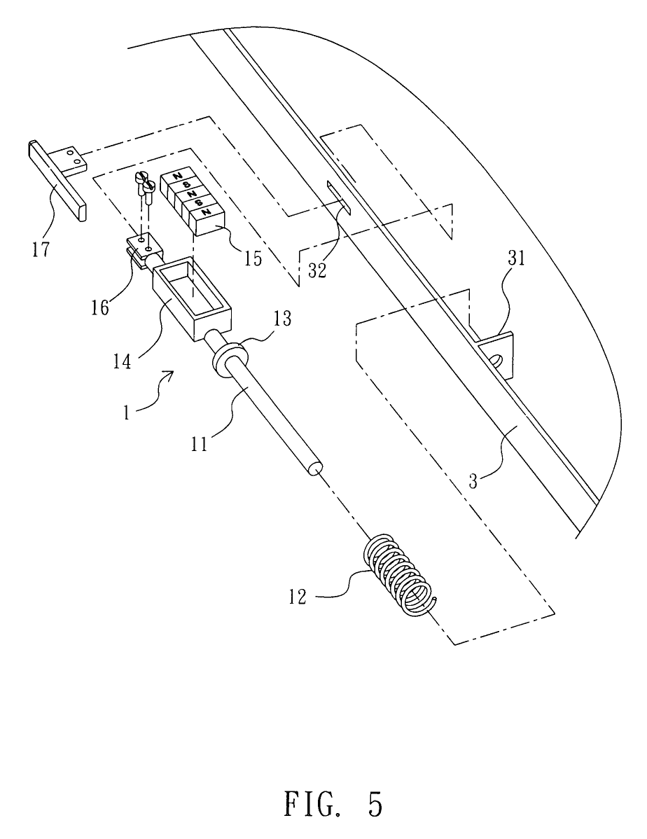

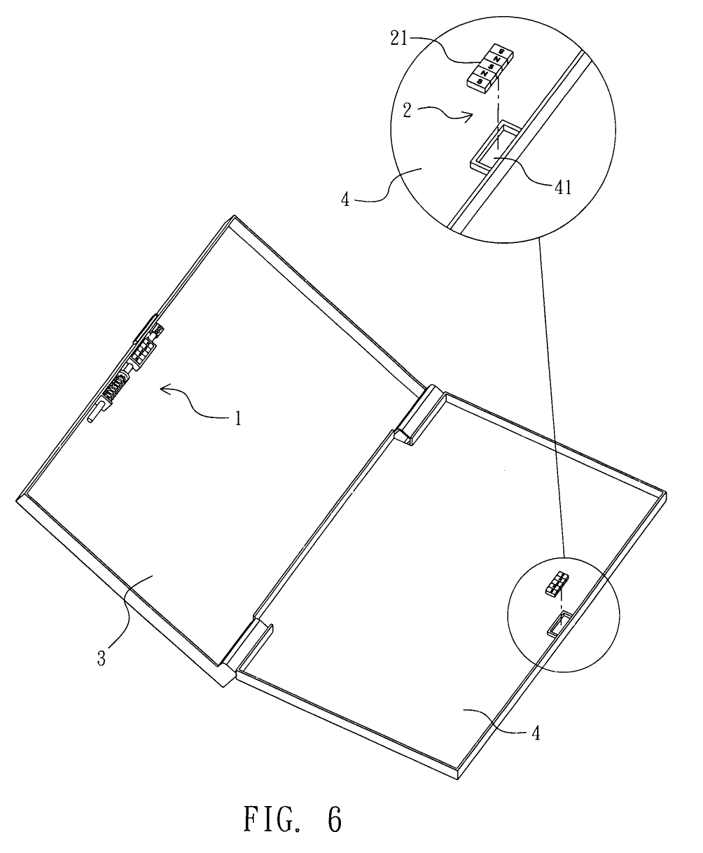

FIGS. 5 and 6 show a magnetic switch in accordance with a second embodiment of the present invention. This embodiment is substantially similar to the aforesaid first embodiment with the exception that the holder member 14 i.e., the box is an elongated container that accommodates a series of reversely arranged magnetic devices 15, and the magnetic devices 21 of the fixed unit 2 are also reversely arranged in series. However, the polarity order, for example, S,N,S,N,S of the magnetic devices 21 of the fixed unit 2 is reversed to the polarity order, for example, N,S,N,S,N of the magnetic devices 15 of the movable unit 1.

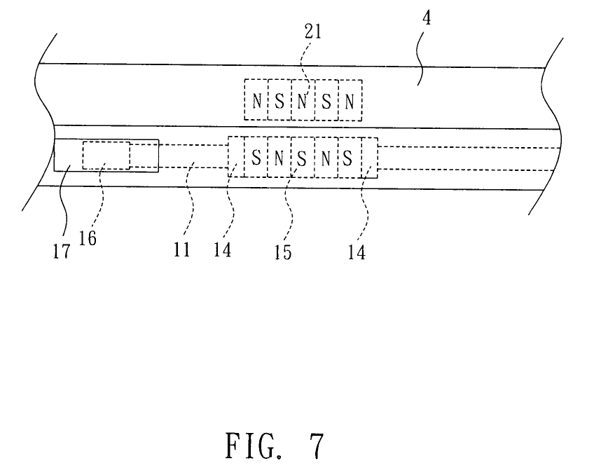

When the first member 3 and the second member 4 are closed, as shown in FIG. 7, a magnetic attractive force is produced between the magnetic devices 21 of the fixed unit 2 and the magnetic devices 15 of the movable unit 1, thereby locking the magnetic switch.

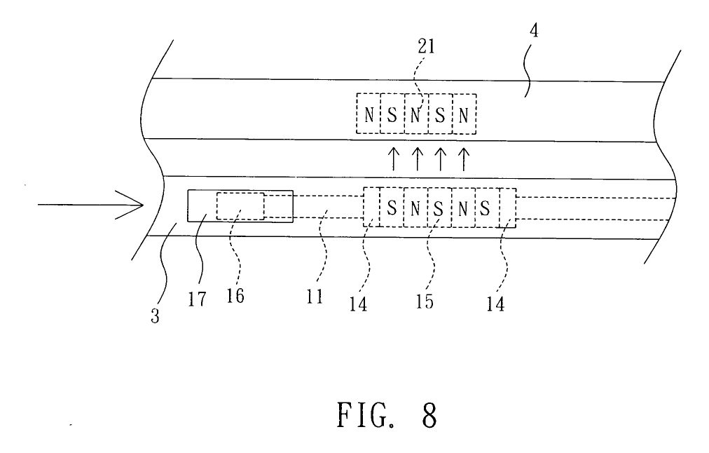

When wishing to unlock the magnetic switch, as shown in FIG. 8, operate the sliding key 17 to move the driven rod 11 with the holder member 14 and the magnetic devices 15 in transverse direction to a predetermined distance to have a magnetic repulsive force be produced between the magnetic devices 21 of the fixed unit 2 and the magnetic devices 15 of the movable unit 1, and therefore the magnetic switch is unlocked.

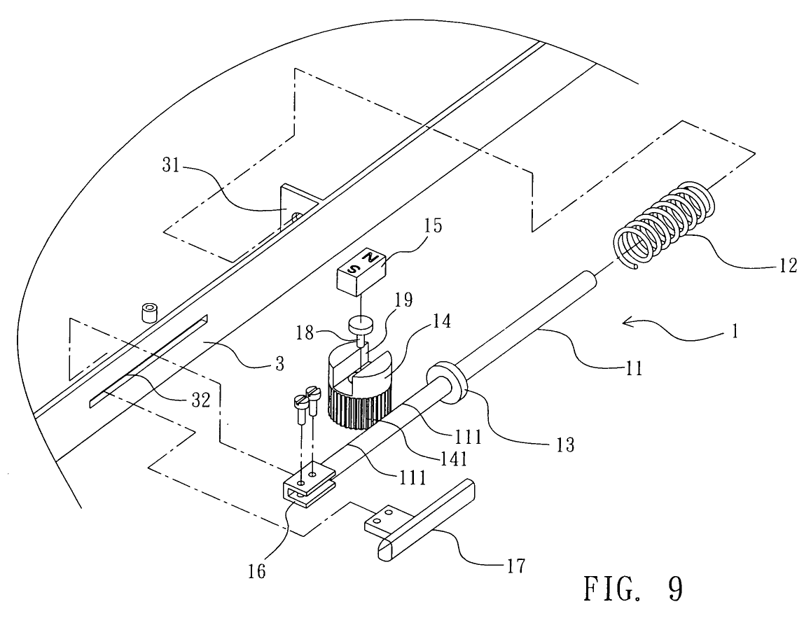

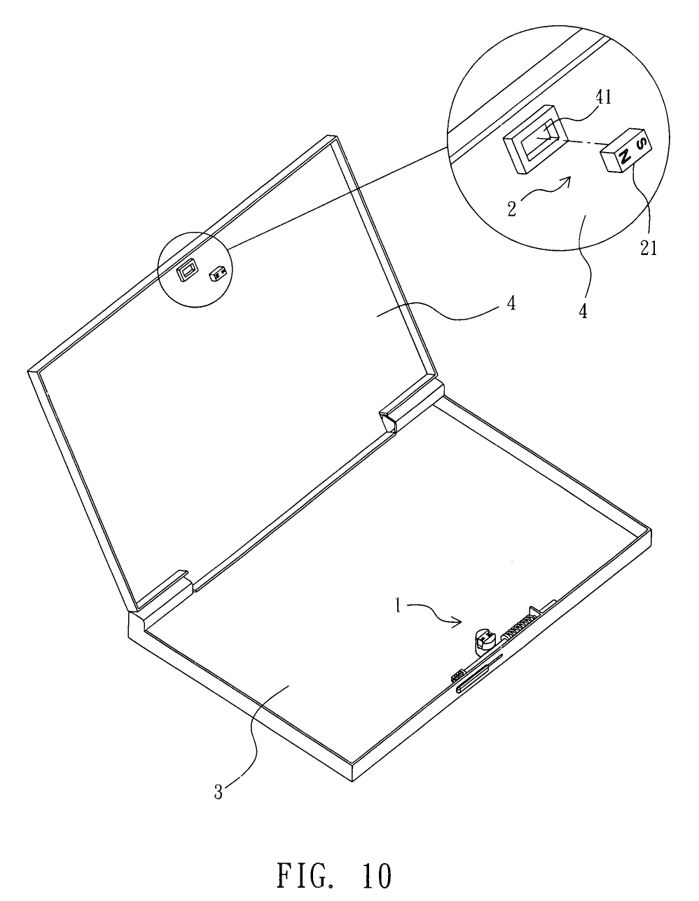

FIGS. 9 and 10 show a magnetic switch in accordance with a second embodiment of the present invention. This embodiment is substantially similar to the aforesaid first embodiment with the exception that the holder member 14 is a gear, which is pivotally mounted inside the front end edge of the first member 3 with a pivot pin 18 and has a series of teeth 141 extending around the periphery and a top chamber 19 for accommodating the magnetic device 15, and the driven rod 11 has a longitudinal rack 111 meshed with the teeth 141 of the holder member 14.

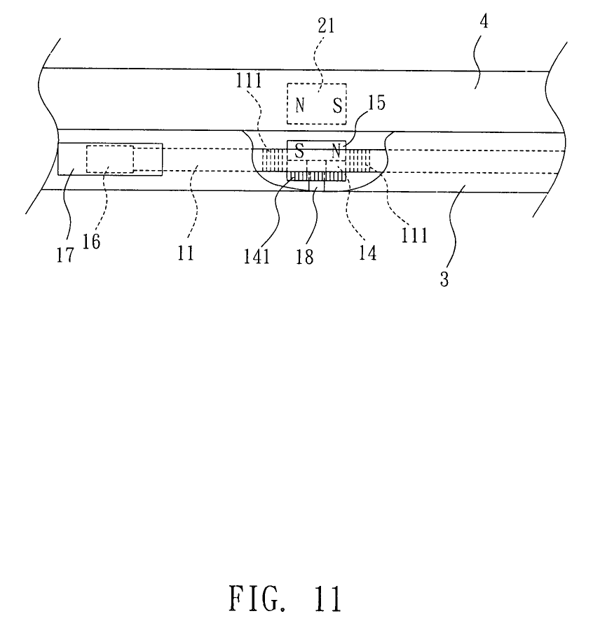

When the first member 3 and the second member 4 are closed, as shown in FIG. 11, a magnetic attractive force is produced between the magnetic devices 21 of the fixed unit 2 and the magnetic devices 15 of the movable unit 1, thereby locking the magnetic switch.

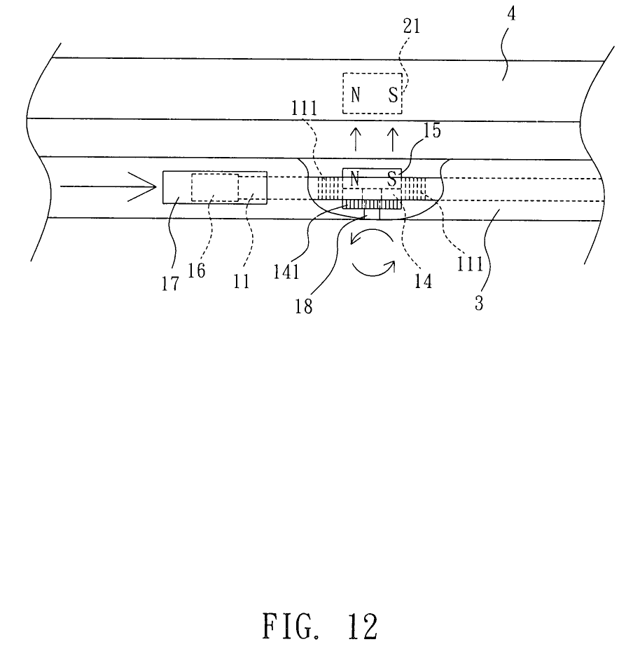

When wishing to unlock the magnetic switch, as shown in FIG. 12, operate the sliding key 17 to move the driven rod 11 in transverse direction to a predetermined distance. Because the longitudinal rack 111 of the driven rod 11 is meshed with the teeth 141 of the holder member 14, moving the driven rod 11 causes the holder member 14 to rotate. When the holder member 14 is rotated through 180°, a magnetic repulsive force is produced between the magnetic device 21 of the fixed unit 2 and the magnetic device 15 of the movable unit 1 to unlock the magnetic switch.

As indicated above, the invention provides a magnetic switch installed in the two hinged members of, for example, a mobile electronic product for locking the two hinged members in the closed position by means of a magnetic attractive force. By means of operating the sliding key to move the driven rod of the movable unit of the magnetic switch in a transverse direction to a predetermined distance, a magnetic repulsive force is produced to unlock the magnetic switch, allowing the user to open the two hinged members of the mobile electronic product with one single hand conveniently.

A prototype of magnetic switch has been constructed with the features of FIGS. 1˜12. The magnetic switch functions smoothly to provide all of the features discussed earlier.

Although particular embodiment of the invention have been described in detail for purposes of illustration, various modifications and enhancements may be made without departing from the spirit and scope of the invention. Accordingly, the invention is not to be limited except as by the appended claims.

What is claimed is:

1. A magnetic switch installed in hinged first member and second member of a lifting cover type article for locking the hinged first member and second member when the hinged first member and second member are closed together, the magnetic switch comprising:
a fixed unit fixedly mounted in a front end edge of the second member of said lifting cover type article, said fixed unit comprising at least one magnetic device;
a movable unit mounted in a front end edge of the first member of said lifting cover type article; said movable unit comprising a driven rod arranged in parallel and movable relative to the front end edge of the first member of said lifting cover type article, a holder member fixedly mounted on said driven rod movable with said driven rod relative to the first member of said lifting cover type article between a first position and a second position, at least one magnetic device mounted in said holder member and adapted to attract the at least one magnetic device of said fixed unit when said holder member is in said first position and to repulse the at least one magnetic device of said fixed unit when said holder member is in said second position, spring means mounted on said driven rod and connected between a part of said driven rod and a part of the first member of said lifting cover type article to support said holder member in said first position, and a key extending out of the front end edge of the first member of said lifting cover type article for operation by the user to move said driven rod relative to the front end edge of the first member of said lifting cover type article against the spring power of said spring means and to further move said holder member from said first position to said second position.

2. The magnetic switch as claimed in claim 1, wherein said lifting cover type article is an electronic product.

3. The magnetic switch as claimed in claim 2, wherein said electronic product is one of mobile computer, personal digital assistant, and electronic dictionary.

4. The magnetic switch as claimed in claim 1, wherein said holder member is a box fixedly fastened to said driven rod; the number of at least one magnetic device of said movable unit is 1 that is mounted in said holder member of said movable unit has two reversed polarities at two ends thereof; the number of the at least one magnetic device of said fixed unit is 1 that has two reversed polarities at two ends thereof.

5. The magnetic switch as claimed in claim 1, wherein said holder member is an elongated box fixedly fastened to said driven rod to accommodate the at least one magnetic device of said movable unit; the at least one magnetic device of said movable unit includes a plurality of magnetic devices reversely arranged in series; the at least one magnetic device of said fixed unit includes a plurality of magnetic devices reversely arranged in series.

6. The magnetic switch as claimed in claim 1, wherein said driven rod is inserted through a lug inside the first member of said lifting cover type article, having a collar; said spring means is a compressed spring sleeved onto said driven rod and stopped between said collar and said lug.

7. The magnetic switch as claimed in claim 1, wherein said key is a sliding member slidably coupled to the first member of said lifting cover type article.

8. The magnetic switch as claimed in claim 1, wherein the magnetic devices of said movable unit and said fixed unit are permanent magnets or electromagnets.

9. A magnetic switch installed in hinged first member and second member of a lifting cover type article for locking the hinged first member and second member when the hinged first member and second member are closed together, the magnetic switch comprising:
a fixed unit fixedly mounted in a front end edge of the second member of said lifting cover type article, said fixed unit comprising at least one magnetic device;
a movable unit mounted in a front end edge of the first member of said lifting cover type article; said movable unit comprising a driven rod arranged in parallel and movable relative to the front end edge of the first member of said lifting cover type article, a holder member pivoted to the first member of said lifting cover type article and rotatable by said driven rod through 180° between a first position and a second position when said driven rod is moved relative to the first member of said lifting cover type article, a magnetic device mounted in said holder member and adapted to attract the at least one magnetic device of said fixed unit when said holder member is in said first position and to repulse the at least one magnetic device of said fixed unit when said holder member is in said second position, spring means mounted on said driven rod and connected between a part of said driven rod and a part of the first member of said lifting cover type article to support said driven rod in the position where said holder member is in said first position, and a key extending out of the front end edge of the first member of said lifting cover type article for operation by the user to move said driven rod relative to the front end edge of the first member of said lifting cover type article against the spring power of said spring means and to further move said holder member from said first position to said second position.

10. The magnetic switch as claimed in claim 9, wherein said lifting cover type article is an electronic product.

11. The magnetic switch as claimed in claim 10, wherein said electronic product is one of mobile computer, personal digital assistant, and electronic dictionary.

12. The magnetic switch as claimed in claim 9, wherein said holder member is a gear wheel pivoted to the first member of said lifting cover type article, having a top chamber; the number of at least one magnetic device of said movable unit is 1 that is mounted in the top chamber of said gear wheel of said holder member of said movable unit and has two reversed polarities at two ends thereof; the number of the at least one magnetic device of said fixed unit is 1 that has two reversed polarities at two ends thereof.

13. The magnetic switch as claimed in claim 9, wherein s said holder member is a gear wheel pivoted to the first member of said lifting cover type article, having a top chamber that accommodates the at least one magnetic device of said movable unit; the at least one magnetic device of said movable unit includes a plurality of magnetic devices reversely arranged in series; the at least one magnetic device of said fixed unit includes a plurality of magnetic devices reversely arranged in series.

14. The magnetic switch as claimed in claim 9, wherein said driven rod is inserted through a lug inside the first member of said lifting cover type article, having a collar; said spring means is a compressed spring sleeved onto said driven rod and stopped between said collar and said lug.

15. The magnetic switch as claimed in claim 9, wherein said key is a sliding member slidably coupled to the first member of said lifting cover type article for moving said driven rod.

16. The magnetic switch as claimed in claim 9, wherein the magnetic devices of said movable unit and said fixed unit are permanent magnets or electromagnets.

17. The magnetic switch as claimed in claim 10, wherein said driven rod has a longitudinal rack; said holder member is a gear wheel pivoted to the first member of said lifting cover type article and meshed with said longitudinal rack.
